(19) United States
(12) Patent Application Publication
(10) Pub. No.: US 2009/0041377 A1
(43) Pub. Date: Feb. 12, 2009

(54) Method and system for defect image correction

(76) Inventor: Albert D. Edgar, Austin, TX (US)

Correspondence Address: Image Trends, Inc.;Suite 450, Building One, 6300 Bridgepoint Parkway, Austin, TX, 78730, US

(21) Appl. No.: 12/221,778

(22) Filed: Aug. 6, 2008

Related U.S. Application Data
(60) Provisional application No. 60/963,595, filed on Aug. 6, 2007.

(51) Int. Cl. G06K 9/40

(52) U.S. Cl. 382/274

(57) ABSTRACT

A method and system for defect image correction is disclosed. The present invention comprises a method and system for defect image correction. The present invention generally relates to detecting and correcting defects in one or more digital images caused by occlusions when the image was taken.

### CROSS REFERENCE TO RELATED APPLICATIONS

This application claims priority under 35 U.S.C. 119(e) to U.S. Provisional Patent Application No. 60/963,595, entitled Method and System for Defect Image Correction, having a priority filing date of Aug. 6, 2007.

### FIELD OF THE INVENTION

This invention generally relates to digital imaging systems and more specifically to a method and system for image correction for digital photography.

### BACKGROUND OF THE INVENTION

Digital cameras have been widely adopted and are being incorporated into new devices, from portable devices like mobile phones to monitoring equipment like security systems. Dust or other occlusions can collect in or on the digital camera and cast a shadow on the image captured by the sensor. The occlusions can sometimes be removed by cleaning, but this does not correct the defects in the images taken before cleaning and maintaining a perfectly clean digital camera is impossible. As a result, nearly all images have defects due to occlusions to one degree or another.

In the past, manual editing of each image was often required to correct the defects. Manually correcting the image is typically done using an expensive professional photo editing software that is difficult to learn and time consuming. As a result, manual correction is generally time intensive, expensive and requires a high degree of skill.

### SUMMARY OF THE INVENTION

The present invention comprises a method and system for defect image correction. The present invention generally relates to detecting and correcting defects in one or more digital images caused by occlusions when the image was taken.

In one embodiment of the present invention, an image correction application is resident on a computer system. In this embodiment, a defect detection program detects the defects in an image using the characteristics of the image. A defect correction program then corrects the defects and produces a corrected image. In a particular embodiment, a user can manually adjust the sensitivity for detecting defects and/or for adjusting the level of defect correction. In a further embodiment, brushes are provided that allow the user to select specific portions of the image to have the defects and/or correction reduced or enhanced. In a further embodiment, the image correction application creates a defect map based on a plurality of images. In yet another embodiment, the defect map is used to create a reference defect map that can be used for multiple combinations of lenses and settings.

Certain embodiments may have all, some or none of the following advantages. One advantage of at least one embodiment is that the negative effects of defects in the images are reduced. Another embodiment of at least one embodiment is that image detail is increased. A further advantage is that the images are more aesthetically pleasing.

Other technical advantages will be readily apparent to one skilled in the art from the following figures, descriptions, and claims.

### BRIEF DESCRIPTION OF THE DRAWINGS

For a more complete understanding of the invention and the advantages thereof, reference is now made to the following description taken in conjunction with the accompanying drawings, wherein like reference numerals represent like parts, in which:

FIG. 1 is a schematic diagram of a digital camera and occlusions that cause defects in an image captured with the camera;

FIG. 2 is a schematic diagram of a digital camera, processing system and image correction application in accordance with one embodiment of the invention; and

FIG. 3 is a flow diagram of the image correction application in accordance with one embodiment of the invention.

### DETAILED DESCRIPTION OF THE PREFERRED EMBODIMENTS

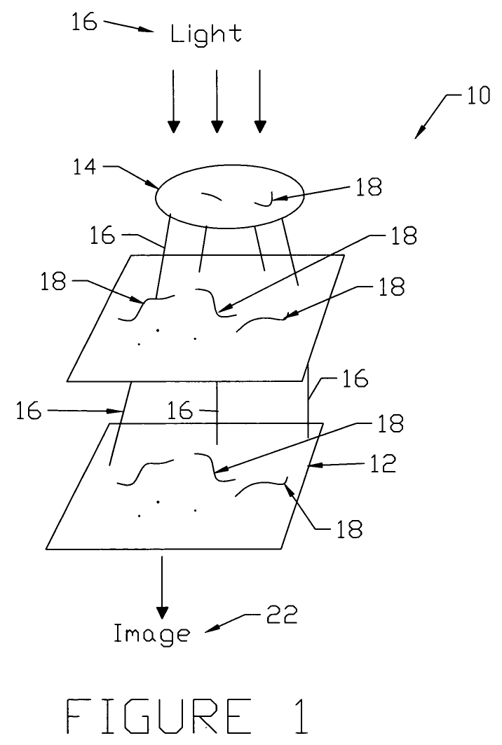

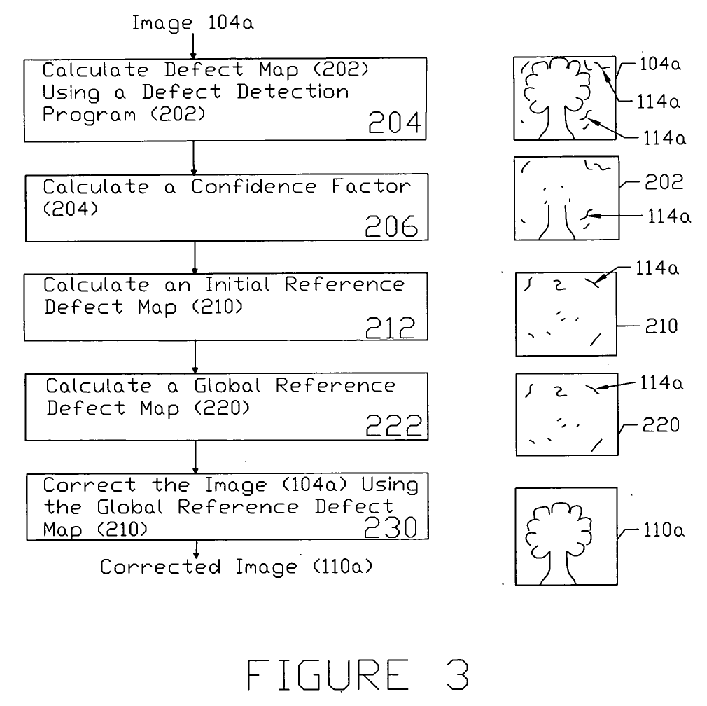

FIGS. 1 through 3 illustrate various embodiments of a method and system for defect image correction. The present invention is illustrated in terms of a software application running on a computer. It should be understood that the present invention may be incorporated directly into the any digital imaging system without departing from the spirit and scope of this invention. For example, the present invention may be incorporated into video cameras, copy machines and other suitable types of sensor imaging systems.

FIG. 1 is a schematic view of an existing digital camera 10 having a sensor 12 and a lens 14. Light 16 entering the lens 14 is blocked by one or more occlusions 18 and causes shadow defects 18 on the sensor 12. The occlusions 18 may be located on the lens 14 or on a cover glass 20 protecting the sensor 12. When a user takes a picture with the digital camera 10, the defects 18 will be also be captures as part of the image 22. The defects 18 in the image 22 detract from the value and enjoyment of the images 22.

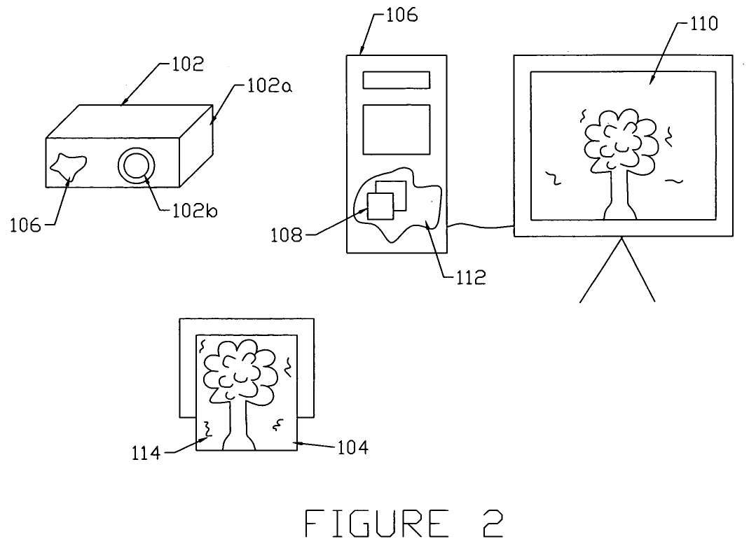

FIG. 2 is a component view of a digital camera 102 operable to capture one or more images 104, a processing system 106 and an image correction application 108 operable to produce one or more corrected images 110. The image correction application 108 can comprise software or hardware residing on the digital camera 102, the processing system 106 or a combination thereof. For purposes of explanation, the present invention is described in terms of a software application running on the processing system 106.

The digital camera 102 may comprise any suitable digital image capture device operable to capture digital images 104. In the preferred embodiment, the digital camera 102 is a conventional digital camera, such as used in standard SLR digital cameras, cell phone cameras and video cameras. In other embodiments, the digital camera 102 may comprise a component of another device, such as a scanner or other suitable system. The digital camera typically includes a body 102a and a lens 102b. The digital image 104 will have specific characteristics based on the camera settings and lens.

The processing system 106 may comprise any suitable electronic processor operable to execute a program. In the preferred embodiment, the processing system 106 comprises a personal computer having memory 112. In this embodiment, the images 104, image correction application 108 and corrected images 110 are stored in memory 112. As discussed previously, the processing system 106 can also be incorporated into the digital camera 102.

The image correction application 108 operates to detect and correct defects 114 caused by occlusions to produce corrected images 110. The occlusions could be dust, hair or any other unwanted material that blocks or diffuses a portion of the light captured by the digital camera 102 to create the images 104. The terms “detect” and “correct” are not intended to require that the image correction application 18 detects and/or corrects all the defects 114, only that at least one defect 114 is detected and maybe corrected.

As described in greater detail below, a defect detection algorithm is used to define the defects 114 and a defect correction algorithm is used to correct the defects 114. In the preferred embodiment, the image correction application 18 utilizes multiple images 104 to create a defect map of the defects 114 that is continuously updated as new images 104 and new defects 114 are processed. The image correction application 108 should also preferably detect and correct the defects 114 automatically on a best efforts basis, but also provides a user with the ability to vary the level of detection and the level of correction. The image correction application 108 may also utilize one or more brushes that the user can use to define areas that the user can modify the detection or correction of defects 114 in the corrected images 110. The image correction application 108 may also allow the user to correct batches of image 104.

FIG. 2 is a flow chart of one embodiment of the image correction application 108. An image 104a is analyzed by a defect detection program 200 to detect defects 114a and create a defect map 202, as shown by step 204. In the preferred embodiment, the defect detection program 200 comprises a median filter within the frequency domain to discriminate between image data and shadows. As described in greater detail below, in the preferred embodiment the defect map 200 comprises the location of the defects 114a for a specific body 102a and lens 102b combination of the digital camera 102. The defect map 200 may also include the degree of occlusion caused by the defects 114a to allow the image correction application 108 to proportionally correct the defects 114a.

In the preferred embodiment, a confidence factor 204 is calculated based on the image data around the defects 114a, as shown in step 206. For example, if the image data is consistent, like a blue sky, and a defect is detected, then there is a higher probability that this is an actual defect 114a. If the image data is similar to the defect, then there is a lower probability that this is a defect 114a. In embodiments where a global reference defect map, as described below, has been determined, the confidence factor 204 also takes into account prior defects 114a in the same area. In a particular embodiment, the confidence factor 204 helps determine the level of correction to apply to the defect 114a.

A reference defect map 210 is then calculated based on the defect map 202 and the confidence factor 204, as shown in step 212. Defects without a high confidence factor 204 are not included in the reference defect map 210 and defects with a high confidence factor 204 are included in the reference defect map 210. It should be understood that the reference defect map 210 applies to the specific combination of lens and camera settings. In certain embodiments, the reference defect map 210 is used to correct the image 104a and produce a corrected image 110a. In the preferred embodiment, a global reference defect map, as described below, is calculated.

A global reference defect map 220 is calculated based on one or more reference defect maps 210 and the specific combination of digital camera 102 settings, such as the lens, f-stop, focal length, etc, as shown in step 222. In the preferred embodiment, the global reference defect map 220 comprises a weighted average of a number of reference defect maps 210. This has the advantage of minimizing the effects of image data. The global reference defect map 220 is also preferably translated to a global reference system that simplifies the application of the global reference defect map 220 to varying camera combinations.

A corrected image 110a is then determined using the global defect reference map 220, as shown in step 230. In the preferred embodiment, each pixel corresponding to a defect 104a within the global defect reference map 220 is proportionally increased or decreased to account for the level of occlusions 18. In defects 104a that are completely occluded, the defect can be blended using image data from around the defect 18.

Throughout the description and claims of this specification the word “comprise,” “includes,” or variations of these words are not intended to exclude other additives, components, integers or steps. While the invention has been particularly shown and described in the foregoing detailed description, it will be understood by those skilled in the art that various other changes in form and detail may be made without departing from the spirit and scope of the invention as set forth in the appended claims.

What is claimed is:

1. A method for correcting images comprising:
receiving a first image having a first desirable image and a shadow image;
receiving a second image having a second desirable image and the shadow image, wherein the second desirable image is different than the first desirable image; and
processing the first and second images to substantially remove the shadow image to produce a first corrected image and a second corrected image.

2. The method of claim 1, wherein substantially removing the shadow image comprising averaging the first image and second image.

3. The method of claim 2, further comprising the step of weighting the first and second image in a progressive relationship to its energy, wherein energy is defined as mean difference in brightness of select pixels from a nominal brightness of pixels averaged across an area.

4. The method of claim 3, wherein the weighting varies spatially across each image based on a region of average.

5. The method of claim 4, wherein the weighting varies in frequency.

6. The method of claim 3, wherein the nominal brightness is found using an average of surrounding pixels.

7. The method of claim 1, wherein the step of processing the images to substantially remove the shadow image includes detecting the shadow image from changes from a select neutral state.

8. The method of claim 7, wherein the changes from a select neutral state is a change in magnification.

9. The method of claim 8, wherein the magnification is derived from metadata associated with the first and second images.

10. The method of claim 9, wherein the metadata used includes focal length.

11. The method of claim 8, wherein the change from a neutral state is a change in blurring of the shadow image.

12. The method of claim 11, wherein the blurring is derived from metadata associated with the deviated image.

13. The method of claim 1, wherein the first image comprises a reference image that provides a reference for detecting the shadow image.

14. An imaging system having software operable to remove a shadow image from a received image to produce a corrected image by functionally dividing a pixel in the received image by a corresponding pixel in the shadow image to produce the corrected image.

15. The imaging system of claim 14, wherein the functional division is a subtraction.

16. The imaging system of claim 15, wherein the functional division is performed by first prescaling a region of the shadow image proportional to an average numerical value of a corresponding region of the received image, and second subtracting a pixel of the prescaled shadow image from the corresponding pixel of the received image.

17. The imaging system of claim 15, wherein the shadow image is pre-corrected relative to the received image.

18. The imaging system of claim 17, wherein the pre-correction includes a magnification change as a function of a focal length.

19. The imaging system of claim 16, wherein the step of subtraction includes generating a safe estimate of the corrected image.

20. The imaging system of claim 19, wherein the safe estimate is the received image acted on by a low pass filter.
